(19) United States
(12) Patent Application Publication
(10) Pub. No.: US 2023/0162300 A1
(43) Pub. Date: May 25, 2023

(54) ARTIFICIAL INTELLIGENCE FOR TRAVEL PARTNER AND DESTINATION RECOMMENDATIONS

(71) Applicant: INTERNATIONAL BUSINESS MACHINES CORPORATION, ARMONK, NY (US)

(72) Inventors: Harish Bharti, Pune (IN); Pinaki Bhattacharya, Pune (IN); Binayak Dutta, Pune (IN); Dinesh Wadekar, Pune (IN); Rajeev Mittal, Gurgaon (IN)

(21) Appl. No.: 17/456,401

(22) Filed: Nov. 24, 2021

(51) Int. Cl. G06Q 50/14; G06Q 50/00; G06N 20/00

(52) U.S. Cl. CPC G06Q 50/14; G06Q 50/01; G06N 20/00

(57) ABSTRACT

A method, computer system, and a computer program product for travel recommendation enhancement are provided. A first travel profile that includes travel preferences is input into a first machine learning model. In response to the inputting, a second travel profile is received from the first machine learning model as a match for the first travel profile. The first machine learning model searches a database of travel profiles and generates at least one weighted directed acyclic graph based on properties of the travel profiles to determine the match. First and second nodes of the at least one weighted directed acyclic graph correspond to the first travel profile and to the second travel profile, respectively. One or more messages presenting the match are generated and transmitted.

### BACKGROUND

The present invention relates generally to the field of automated travel advisement and to the enhancement of travel experiences by automated recommendation systems.

### SUMMARY

According to one exemplary embodiment, a method for travel recommendation enhancement is provided. A first travel profile that includes travel preferences is input into a first machine learning model. In response to the inputting, a second travel profile is received from the first machine learning model as a match for the first travel profile. The first machine learning model searches a database of travel profiles and generates at least one weighted directed acyclic graph based on properties of the travel profiles to determine the match. First and second nodes of the at least one weighted directed acyclic graph correspond to the first travel profile and to the second travel profile, respectively. One or more messages presenting the match are generated and transmitted. A computer system and computer program product corresponding to the above method are also disclosed herein.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a travel recommendation process according to at least one embodiment;

FIG. 3 is an operational flowchart illustrating a supplementary travel recommendation process according to at least one embodiment and which supplements the travel recommendation process that is shown in FIG. 2;

FIG. 4 is a high-level pipeline representation of a software design according to at least one embodiment and that is enabled to carry out one or both of the travel recommendation process depicted in FIG. 2 and the supplementary travel recommendation process that is depicted in FIG. 3;

FIG. 5 is a portion of a directed acyclic graph according to at least one embodiment and that may be generated as part of the travel recommendation process that is shown in FIG. 2;

FIG. 6 is a block diagram of internal and external components of computers and servers depicted in FIG. 1 according to at least one embodiment;

FIG. 7 is a block diagram of an illustrative cloud computing environment including the computer system depicted in FIG. 1, in accordance with an embodiment of the present disclosure; and

FIG. 8 is a block diagram of functional layers of the illustrative cloud computing environment of FIG. 7, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a system, method, and computer program product for enhancing travel recommendation by automatically evaluating a number of profiles each representing a respective traveler or another travel-related object and by pairing travelers and activities who match well. Solo travelling has existed for ages and has allowed individuals to achieve some self-discovery and to meet new people and cultures. Quality companionship may enhance a travel experience as multiple individuals enjoy the travel experience together. The present embodiments may enhance software programs that have been used to help match potential travel partners and may enhance the authenticity and safety of travel partner pairing. The present embodiments may help overcome challenges associated with fake profiles and catfishing that may occur on traditional travel recommendation programs. The present embodiments may implement a machine learning based cognitive framework to achieve enhanced recommendations for travel partners and travel activities, with the recommendations being extendible to other aspects of travel as well such as finding a reliable tour guide, choosing appropriate audio tours, and finding a suitable host. The present embodiments dynamically help with the personal decision/selection of a travel companion who may be reliable and/or safe and compatible with respect to personality traits and habits. The present embodiments may result in an elevated travel experience. The present embodiments may help match as travel partners people who have similar travel tastes or interests. For example, the present embodiments may help pair as travel partners people who are obsessed with data or facts, who hold similar personality attributes, and/or who like particular activities such as tasting local food on a walking tour.

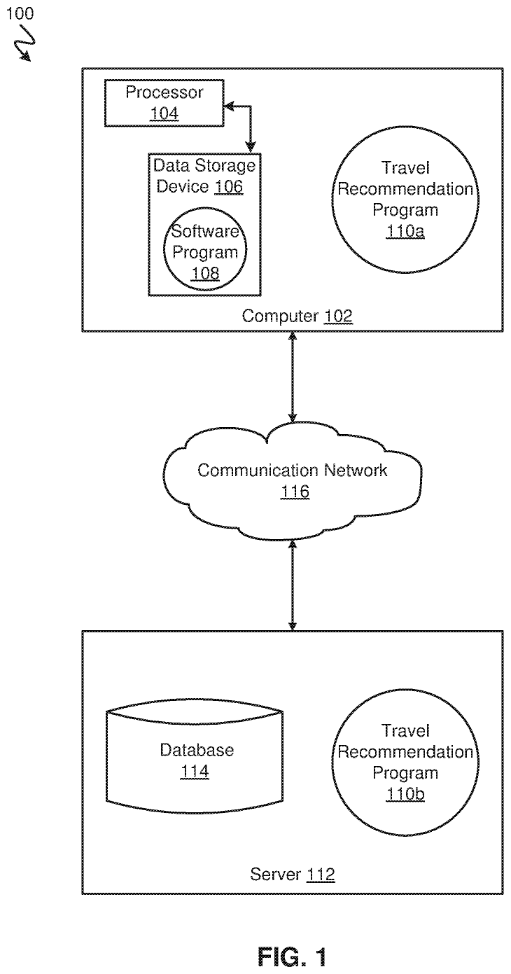

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a travel recommendation program 110a. The networked computer environment 100 may also include a server 112 that is a computer and that is enabled to run a travel recommendation program 110b that may interact with a database 114 and a communication network 116. The server 112 may include a plurality of engines, modules, and recommendation generators that are subsequently described and/or may use the communication network 116 to access other servers which host such engines, modules, and recommendation generators. The networked computer environment 100 may include a plurality of computers 102 and servers 112, although only one computer 102 and one server 112 are shown in FIG. 1. The communication network 116 allowing communication between the computer 102 and the server 112 may include various types of communication networks, such as the Internet, a wide area network (WAN), a local area network (LAN), a telecommunication network, a wireless network, a public switched telephone network (PTSN) and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

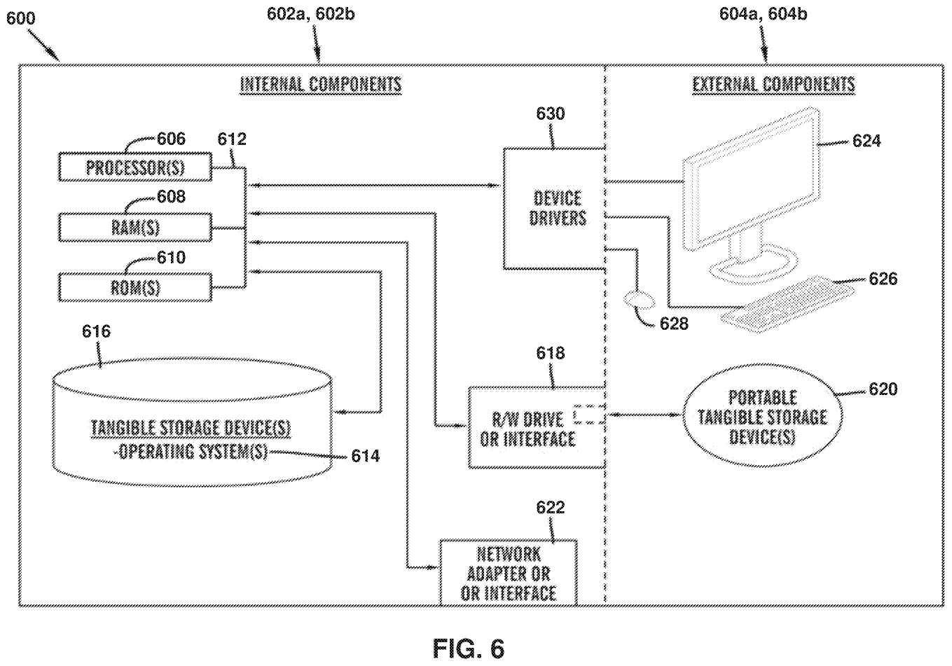

The client computer 102 may communicate with the server 112 via the communication network 116. The communication network 116 may include connections such as wire, wireless communication links, and/or fiber optic cables. As will be discussed with reference to FIG. 6, server 112 may include internal components 602a and external components 604a, respectively, and client computer 102 may include internal components 602b and external components 604b, respectively. Server 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114 in a server 112 that is remotely located with respect to the client computer 102. The client computer 102 will typically be mobile and include a display screen and a camera. According to various implementations of the present embodiment, the travel recommendation program 110a, 110b may interact with a database 114 that may be embedded in various storage devices, such as, but not limited to a computer/mobile device 102, a networked server 112, or a cloud storage service.

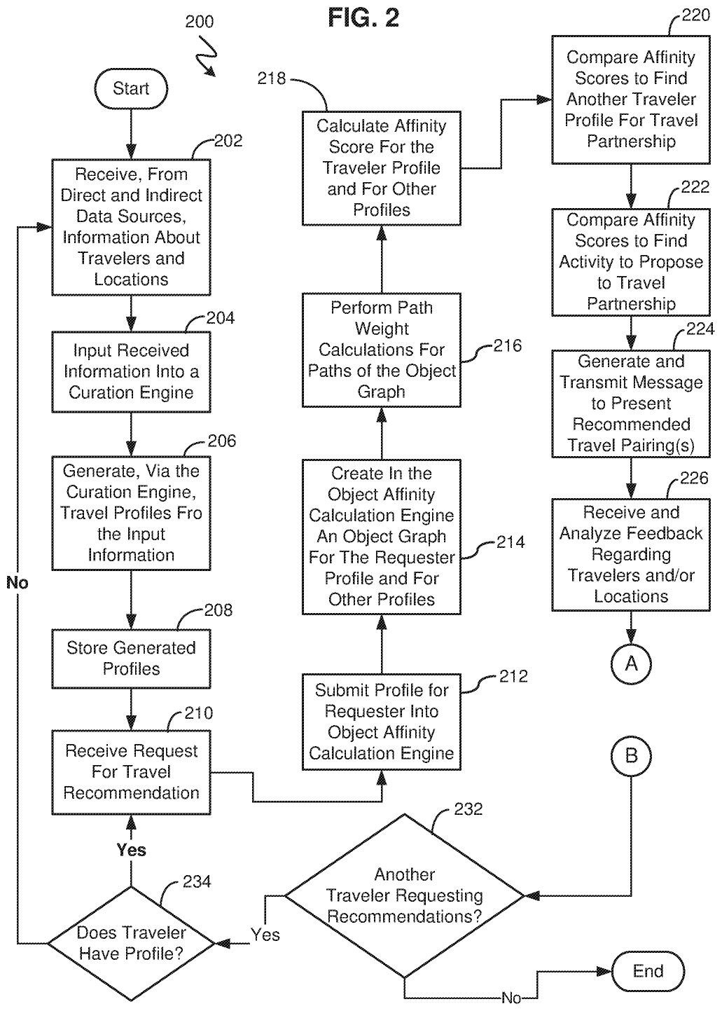

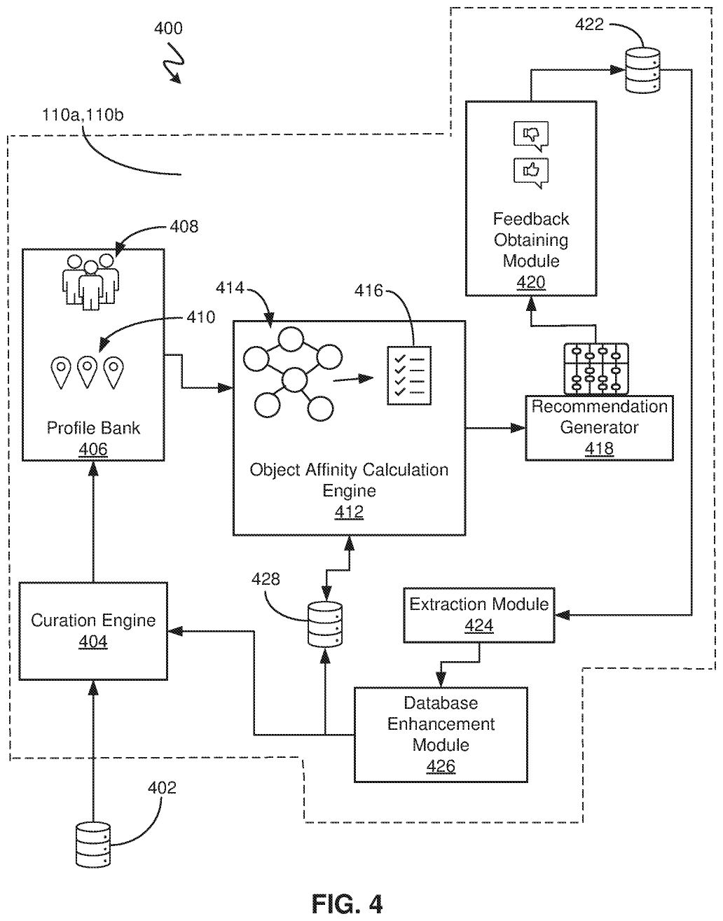

Referring now to FIG. 2, an operational flowchart depicts a travel recommendation process 200 that may, according to at least one embodiment, be performed by the travel recommendation program 110a, 110b. FIG. 4 which will be described along with FIG. 2 shows a pipeline 400 that is an example of a software system that may be used to perform the travel recommendation process 200. The pipeline 400 shown in FIG. 4 shows that the travel recommendation program 110a, 110b may include various modules, user interfaces, machine learning models, and/or services and may use data storage to perform the travel recommendation process 200. A computer system with the travel recommendation program 110a, 110b operates as a special purpose computer system in which the travel recommendation program 110a, 110b assists a traveler to improve travel enjoyment by matching the traveler with suitable potential travel partners and activities. In particular, the travel recommendation program 110a, 110b transforms a computer system into a special purpose computer system as compared to currently available general computer systems that do not have the travel recommendation program 110a, 110b.

In a step 202 of the travel recommendation process 200, information about travelers and locations are received from direct and indirect data sources. In the pipeline 400 shown in FIG. 4, structured and unstructured data from direct and indirect data sources 402 may be ingested as information by the curation engine 404.

This information may be directly received from a traveler via a prompt and graphical user interface that is generated by the travel recommendation program 110a when a user accesses the travel recommendation program 110a, e.g., via the computer 102. This direct information may include demographical information about the user, travel preferences of the user, and travel constraints to which the user is subjected. The gathering of this information may be subject to data laws, privacy consent, and service acceptance. Travel preferences may include activity type, location type, mode of travel, length of travel stay, travel group size, travel budget, travel eating, travel housing, travel dates, etc. Constraints may overlap with travel preferences and may include travel dates, travel budget, travel eating, etc.

Information may be obtained from indirect data sources via the travel recommendation program 110a, 110b scrawling through social media accounts, messages, device or online picture banks of a user, e.g., stored in the data storage device 106 of the computer 102, and/or travel rating websites where a user gave a rating, and/or other online sources. A user may give consent to the travel recommendation program 110a, 110b for the travel recommendation program 110a, 110b to scrawl such data sources in order to help build a travel profile that represents the interests, preferences, and past travel experiences of a particular user. The travel recommendation program 110a, 110b accessing social media sites to obtain information may give an initial enhancement of accuracy of information and, therefore, safety for the pairing process, because information is gathered that has been presented to the public in some manner. Information given directly to the travel recommendation program 110a, 110b by the user may be supplemented by this additional indirect information. As a user may be more likely to give accurate information if the information has some aspect of being available or publicly presented, using such information to build a profile may result in increased accuracy and increased safety for other users of the travel recommendation program 110a, 110b.

The travel recommendation program 110a, 110b may receive other information to generate a travel profile by receiving one or more digital files, e.g., via the communication network 116 that is shown in FIG. 1. The receiving may occur via the travel recommendation program 110a receiving an uploaded file at the computer 102 or via the travel recommendation program 110b at the server 112 receiving a file with travel information, preferences, experiences, and/or constraints of a particular user. Such file may have been transmitted from the computer 102 through the communication network 116 to the server 112.

The gathering of the information may help deduce and rank interest of a traveler or another travel-related object. The gathering may include probing the text data to elicit tourist spots by name. The gathering may include an image search/match that includes finding and analyzing pictures chosen and mapped to tourist spots. The gathering of the information may include asking about previous tourism experiences for a user. Other travel interest factors may be gathered as well.

The gathering of information may also result in the derivation of constraints and the creation of eligibility thresholds. The gathering of information may include gathering a present location and a medical condition, e.g., allergies, of a user. The gathering of information may include gathering travel group information such as number of persons in a potential traveling group, ages of the people in the group, and any familial relationships of those in the group. For example, if a potential traveling group includes children and/or senior citizens, travel opportunities may differ compared to other groups with all young adults or mid-aged adults. The gathering of information may include the gathering of travel preferences and constraints and monetary constraints and/or trip budgets. The gathering of information may include gathering of a travel readiness indication and intended travel dates. Other constraint and eligibility considerations may be gathered as well.

For data gathering for a location or tourist spot, dimensions and attributes of the tourist spots may be gathered. The natural condition of the location, e.g., whether there is a cold environment with snow, a tropical location with a beach, a hot location in a desert, may be determined via question asking via the graphical user interface generated by the travel recommendation program 110a, 110b. A variety and type of activities available at a destination may be gathered. For example, whether skiing, sailing, rafting, historical site-seeing, sight-seeing, etc. is/are available at a location may be determined via automated question asking and data scrawling. An optimal travel time, e.g., an optimal travel season, for a location may be determined. Seasonal constraints may be determined. Suitability of infrastructure for accommodating different compositions of tourist groups may be determined, e.g., whether the infrastructure is suitable for hosting couples, groups, riders, religiously diverse groups, etc. Food options available at a location may be determined, e.g., types of restaurants and their cuisines and grocery stores that are available and/or accessible at a location. Danger factors and security factors may be determined for an area by soliciting feedback and scrawling public news sources such as newspapers and news sites. Various length of stay options for a location may be determined. Modes of travel that are possible for a location may be determined, e.g., whether an airport or train line is in the area. Any other travel constraints such as age requirements, medical condition requirements, and/or citizenship requirements may be determined.

Such data gathering for a location may be initiated by a community tourism leader of the area or by a worker for a company implementing the travel recommendation program 110a, 110b. Such data gathering for lodging may be initiated by an owner of the lodging site or a worker at the lodging site.

For service providers such as agencies or individuals, the gathering of information may include the automated collecting service offerings and advertisements from the service provider, collecting public ratings and advisories regarding the location, and collecting feedback from registered third-party sources, e.g., via application programming interfaces (APIs) and via web scraping. The gathering may include collecting feedback and ratings from tourists or users who have visited the location or lodgings.

For tourist locations or destinations, the gathering of information may include automated collecting of advisory ratings from the public and from registered third party sources, e.g., via APIs and web scraping. Images and videos may be gathered, subject to suitable copyright law, from the public and from registered third-party data sources when allowed by law and/or explicitly consented to by subjects. The gathering may include collecting feedback and ratings from tourists or users who have visited the tourist location/destination.

An initiation signal or request to gather information and data for a respective party, e.g., a prospective traveler and/or other travel-related object, as part of step 202 may be received by the travel recommendation program 110a at the computer 102 and/or may be transmitted via the communication network 116 and received by the travel recommendation program 110b at the server 112. An individual may access a public portal of a website that presents the travel recommendation program 110a, 110b and may enter information into a graphical user interface of the website to initiate and provide authorization for such data gathering. Such initiation may be imminently followed by a user providing personal and travel information in response to a number of questions that were presented to the user via a graphical user interface of a website and displayed on a computer of the user, e.g., on the computer 102.

The information may be used to help form a pairing taxonomy based on deducing and ranking interests of travelers, deriving constraints, creating eligibility thresholds for a traveler, and deriving dimensions for locations.

In a step 204 of the travel recommendation process 200, the received information is input into a curation engine. This received information may be that information that was received in step 202. FIG. 4 shows a curation engine 404 as an example of the curation engine involved in step 204. The curation engine 404 may perform natural language processing and other text analytics on ingested text data that is received in step 202. The curation engine 404 may perform image analysis on any photo that is received as part of the data in step 202, for example comparing the photo with existing photos that have previously been identified as capturing images of respective particular travel destinations (subject to any relevant restrictions by law in the region, state, or country). The curation engine 404 may be part of the traveler recommendation program 110a, 110b. The curation engine 404 may include a machine learning model as a type of artificial intelligence that has been trained to recognize certain kinds of patterns in text and/or images in order to perform the necessary comparison. The machine learning model may receive, as input, data and may, as output, classify the input data in some manner. Supervised and unsupervised learning may be used for the training of the machine learning model in various embodiments of the invention. The machine learning model may already be trained by the time that step 204 is performed when the received information is input into the curation engine 404.

In a step 206 of the travel recommendation process 200, the curation engine 404 generates travel profiles about the respective travel objects from the input information. The input information may be that information that was received by the curation engine 404 in step 204. The machine learning model of the curation engine 404 may be involved in the generating of the travel profiles. Specifically, the machine learning model may receive as input the structured and/or unstructured data that was received in step 202 and that was input into the curation engine 404 in step 204. The machine learning model may provide as output the travel profiles. Each travel profile may constitute a collection of travel information, preferences, plans, previous travel experiences, personality characteristics, and/or constraints for a respective traveler. For any entity which is not a traveler but is some other travel-related object such as a destination locale, a host, an audio tour presentation, a tour guide, and/or an activity, the travel profile created for such object may include style, personality characteristics, constraints, preferences, previous travelers engaged and/or accommodated, and/or future plans for the respective travel-related object. The variables of each profile may be stored as numeric values in a scaled rating system, e.g., with high numeric values indicating a strong measure for a certain variable and with low numeric values indicating a weak measure for a certain variable. The work of the curation engine 404 may help iteratively enrich dimensions of traveler profiles, location profiles, and/or other travel-related profiles.

In a step 208 of the travel recommendation process 200, the generated profiles are stored. The generated profiles may be those profiles that are generated in step 206. The generated profiles may be stored in computer memory and/or a computer readable storage medium that is associated with the traveler recommendation program 110a, 110b. For example, the generated profiles may be stored in the data storage device 106 of the computer 102 and/or in the database 114 of the server 112 that are shown in FIG. 1. The profile bank 406 shown in the pipeline 400 in FIG. 4 may also be a computer memory and/or a computer readable storage medium. The profile bank 406 is shown as storing traveler profiles 408 which correspond respectively to individual or group travelers seeking to obtain travel recommendations from the travel recommendation program 110a, 110b. The profile bank 406 is shown as storing location profiles 410 which correspond respectively to travel locations which individual travelers may find desirable as a destination site and/or which may be seeking to promote travel and/or tourism for their location and, therefore, wish to participate in the travel recommendation program 110a, 110b and to be matched with potential travelers. The profiles that are generated may be stored in memory that is part of the travel recommendation program 110a, 110b or that is accessible to the travel recommendation program 110a, 110b. For example, the generated profiles may be saved in the RAM 908 that is shown in FIG. 6, in memory of a server within and connected to the communication network 116, and/or in other memory in one or more remote servers that are accessible to the travel recommendation program 110a, 110b via the communication network 116 and/or via a wired connection. Thus, the profile bank 406 may include one of the types of computer memories described in the preceding or foregoing.

In a step 210 of the travel recommendation process 200, a request for a travel recommendation is received. This request may be received by the travel recommendation program 110a at the computer 102 or may be transmitted via the communication network 116 and received by the travel recommendation program 110b at the server 112. A prospective traveler who has intentions to undertake travel in the future, e.g., in the near future, may submit this request. A representative of a travel destination or lodging may submit such request to find a suitable individual to whom they may advertise their destination, activities, and/or lodging. Such request may be generated by a user actuating a request button in a graphical user interface of a website of the travel recommendation program 110a, 110b, e.g., using a keyboard 626, computer mouse 628, or touch screen of the computer 102. For the request to correctly function, it may be necessary that a profile for the requester already have been created for the requester. Such profile may have been created in steps 202 to 208. The profile corresponding to this requester may have already been generated and stored in the profile bank 406, e.g., amongst the traveler profiles 408.

In a step 212 of the travel recommendation process 200, a profile for the requester is submitted into an object affinity calculation engine. This requester whose profile is submitted may be the individual whose request was received in step 210. The requester may be representing themselves as a traveler or may represent an entity such as a hotel, travel destination, and/or other lodging. The pipeline 400 shown in FIG. 4 includes an object affinity calculation engine 412 which may include one or more machine learning models. These one or more machine learning models may be part of or in addition to a machine learning model that is part of the curation engine 404. A profile may be accessed from memory and placed into a memory buffer and/or directly into the object affinity calculation engine 412. For embodiments where the object affinity calculation engine 412 is disposed in a remote server that is separate from the server 112, the submission of step 212 may include a data transmission, e.g., a transmission of the selected profile, over the communication network 116 from the server 112 to such other remote server. For instances when the travel recommendation process 200 is being performed as repeat of a repeated iteration, the object affinity calculation engine 412 may access one or more previously generated object graphs in an object graph database 428 in order to facilitate object graph creation and, therefore, object affinity calculation.

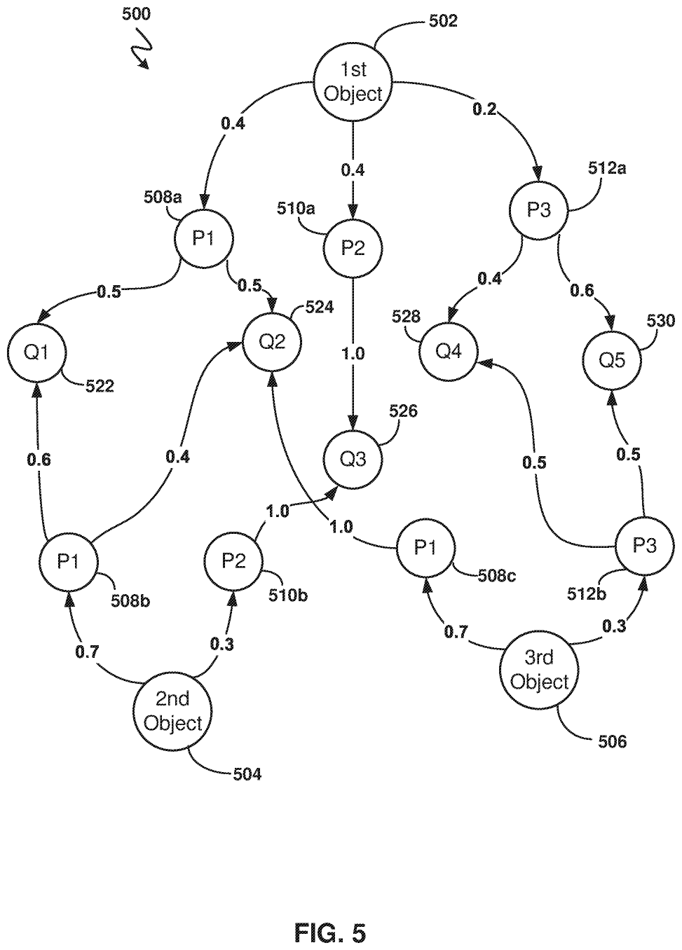

In a step 214 of the travel recommendation process 200, an object graph for the requester profile and for other profiles is created in the object affinity calculation engine 412. The requester profile may be the profile that was submitted in step 212. The other profiles may be obtained from the profile bank 406. Within the object affinity calculation engine 412 an object graph creation module 414 may create and/or generate the object graph for the requester profile and for other profiles. The object graph may be a weighted directed acyclic graph (DAG) with directed edges that are weighted to represent linkage of properties and qualifiers for the objects. The weighted DAG may be a heterogeneous DAG and may be a multi-level DAG, e.g., a three level DAG. FIG. 5 shows an example of a weighted DAG 500 that is an example of the object graph that is created in step 214.

The object affinity calculation engine 412 helps provide recommendations for best available travel object pairing options, e.g., traveler pairing options, by employing object affinity calculation to utilize and evaluate a lineage of interests and/or characteristics of a travel object compared to those of another travel object. This comparison and tracking help identify which travel objects in the group have a highest degree or high degrees of complementary attributes between them. The object affinity calculation engine 412 may perform three main steps including graph creation, path weight calculation, and affinity score calculation.

The graph creation may include identifying properties in the travel profile and qualifiers of those properties. The properties may be considered as categories and the qualifiers may be considered as sub-categories. A grade and/or magnitude of each property and qualifier may also be determined. These identifications may occur at the object graph creation module 414 or may occur earlier in the profile generation that is performed by the curation engine 404.

A first level of the multi-level directed acyclic graph may be the travel object, e.g., a particular traveler, destination, host, audio tour, etc. A second level of the multi-level DAG may be the various properties. A third level of the multi-level DAG may be qualifiers of the properties. As a single graph may connect the profiles for the various travel objects, e.g., the various traveler profiles, analysis of a single graph may help clarify affinity of certain travel objects, e.g., travelers, to each other as opposed to other travelers who have been profiled. In other embodiments, multiple DAGs may be created and analyzed to perform the travel recommendations.

FIG. 5 shows as the first level of the weighted DAG 500 the first object 502, the second object 504, and the third object 506. These first, second, and third objects 502, 504, 506 may be directly linked in the weighted DAG 500 to certain properties and are indirectly linked in the weighted DAG 500 to each other.

The properties may be travel group size preferences, travel food consumption preferences, personality preferences, e.g., whether a traveler is fact driven, travel budget preferences, activity preferences, travel calendaring preferences, etc. Other properties and/or preferences have been described elsewhere in this disclosure. The properties and preferences described herein are examples and other properties and preferences may be included for the object graph creation.

For example, the first, second, and third objects 502, 504, 506 each have an individual link to a property P1, with the first object 502 being linked to the first first property 508a, the second object 504 being linked to another first property 508b and the third object 506 being linked to a further first property 508c. The first first property 508a, the other first property 508b, and the further first property 508c are each indicated with P1 in FIG. 5. This property P1 may be related to travel calendaring preferences or to travel group size considerations or to some other travel-related property.

Further, the first and the second objects 502, 504 each have an individual link to a property P2, with the first object 502 being linked to the first second property 510a, and the second object 504 being linked to another second property 510b. The first second property 510a and the other second property 510b are each indicated with P2 in FIG. 5. This property P2 may be related to activity type preferences or traveler partner personality preferences or to some other travel-related property.

Further, the first and the third objects 502, 506 each have an individual link to a property P3, with the first object 502 being linked to the first third property 512a and the third object 506 being linked to another third property 512b. The first third property 512a and the other third property 512b are each indicated with P3 in FIG. 5. This property P3 may be related to travel food preferences/constraints or to some other travel-related property.

In the weighted DAG 500 shown in FIG. 5 that is an example of a graph created by the object affinity calculation engine 412, the various properties P1, P2, P3 together constitute a second level of the multi-level weighted DAG.

The properties may be linked to various qualities. For example, for a food property the various qualities of food budget, food type preferences, meal or eating time, and food priority (e.g., the importance of food considerations during travel as compared to other travel considerations) may all be linked to further define the food preferences and priorities for a traveler. The qualities described herein are examples. Other qualities and sub-categories may be included for the object graph creation.

For example, the weighted DAG 500 shown in FIG. 5 includes first, second, third, fourth, and fifth qualifiers 522, 524, 526, 528, and 530, respectively. The first qualifier 522 has linked paths to both the first first property 508a and to the other first property 508b. The second qualifier 524 has linked paths to each of the first first property 508a, the other first property 508b, and the further first property 508c. The third qualifier 526 has linked paths to both the first second property 510a and to the other second property 510b. The fourth qualifier 528 has linked paths to both the first third property 512a and to the other third property 512b. The fifth qualifier 530 has linked paths to both the first third property 512a and to the other third property 512b. Thus, in the weighted DAG 500 the qualifiers Q1 and Q2 are sub-categories for P1, the qualifier Q3 is a sub-category for P2, and the qualifiers Q4 and Q5 are sub-categories for P3.

In an example where the P1 properties represent travel calendaring preferences, the Q1 may as the first qualifier 522 represent a tour duration qualifier indicating how long the traveler would like the trip to last. In this example where the P1 properties represent a travel calendaring preferences, the Q2 may as the second qualifier 524 represent a travel start date qualifier indicating the date the traveler would like the trip to start. Both the Q1 and the Q2 in this example are sub-categories of the P1 property for travel calendaring preferences.

In an example where the P2 properties represent travel activity preferences, the Q3 may as the third qualifier 526 represent a history qualifier indicating how much the traveler values visiting historical sites during travel. The Q3 in this example is a sub-category of the P2 property for travel activity preferences.

In an example where the P3 properties represent travel food constraints/preferences, the Q4 may as the fourth qualifier 528 represent a spice qualifier indicating a value of how much the traveler enjoys and/or avoids eating spicy foods during travel. In this example where the P3 properties represent travel food constraints/preferences, the Q5 may as the fifth qualifier 530 represent a vegan qualifier indicating that the traveler eats or avoids vegan food.

In the weighted DAG 500 shown in FIG. 5 that is an example of a graph created by the object affinity calculation engine 412, the various qualifiers Q1, Q2, Q3, Q4, and Q5 together constitute a third level of the multi-level weighted DAG.

In the weighted DAG 500 shown in FIG. 5, a number of the object nodes which are the first level may indicate a number of travelers or travel objects that are compared, Pⱼ may denote the j^{th} property vertex of the respective linked object, and Qₖ may denote the k^{th} qualifier vertex of the Property Pⱼ. Each edge in the weighted DAG 500 may be directed and weighted to represent object-property-qualifier relations. Weights for the edges may be derived from direct and indirect data sources such as social media, feedback loops, and various rating systems that were used for profile curation. Some of the steps of the travel recommendation process 200 may invoke path aggregation to provide a pairing score which reflects an overall compatibility of a proposed pair.

All object nodes in the object graph need not have all the properties or all the qualifiers. For example in the weighted DAG 500 shown in FIG. 5, the 2^{nd} Object 504 is not directly connected to any property node P3. If the P3 property node relates to food constraints, this lack of direct connection to a food property node may indicate that for a traveler 2 represented by the 2^{nd} object 504 food considerations are low on their priorities and they have extreme flexibility about various options that could satisfy them for the travel. In this instance where a user has a negligible value for one or more properties, the object affinity calculation engine 412 may dynamically give higher weights to other properties that are directly linked to this respective object node.

In a step 216 of the travel recommendation process 200, path weight calculations for paths of the object graph are performed. This object graph may be that object graph that was created in step 214. For a selected object, the location of the object node that corresponds to the selected object is identified within the weighted DAG 500. For each property node that is directly linked to the selected object node, a weighted path is calculated from the object node. Additionally, for each qualifier node in the object graph a weighted path is calculated starting from the object node, passing through the linked property node, and ending in the qualifier node connected to the property node. For example, if three qualifier nodes are connected to a particular property node, then three path weight calculations may be performed respectively for the three paths that start from a single object node, run through the property node, and end respectively at one of the three qualifier nodes. A path weight for each of these paths may be determined via the formula of a first edge weight of the first path portion multiplied by a second edge weight of the second path portion. The formula may be indicated with: Path_Weight (OᵢPⱼQₖ)=Edge_Weight(OᵢPⱼ)×Edge_Weight(PᵢQₖ)

This formula may also be indicated with:

PathWeight(OᵢPⱼQₖ)=Σ EdgeWeight(OᵢPⱼ)*EdgeWeight(PⱼQₖ)with 0<j≤m and 0<k≤n

where Oᵢ denotes the i^{th} Object Node, Pⱼ denotes the j^{th} Property Node of Object Oi, and Qₖ denoted the k^{th} Qualifier Node of Property Pⱼ.

Path weight calculations for the weighted DAG 500 shown in FIG. 5 are provided as examples in Table 1 below.

TABLE 1

| Traveler | Path | Edge | Path Weight |
|---|---|---|---|
| Traveler 1: O₁ | O₁P₁Q₁ | O₁P₁ * P₁Q₁ | 0.2 |
| | O₁P₁Q₂ | O₁P₁ * P₁Q₂ | 0.2 |
| | O₁P₂Q₃ | O₁P₂ * P₂Q₃ | 0.4 |
| | O₁P₃Q₄ | O₁P₃ * P₃Q₄ | 0.08 |
| | O₁P₃Q₅ | O₁P₃ * P₃Q₅ | 0.12 |
| Traveler 2: O₂ | O₂P₁Q₁ | O₂P₁ * P₁Q₁ | 0.42 |
| | O₂P₁Q₂ | O₂P₁ * P₁Q₂ | 0.28 |
| | O₂P₂Q₃ | O₂P₂ * P₂Q₃ | 0.3 |
| Traveler 3: O₃ | O₃P₁Q₂ | O₃P₁ * P₁Q₂ | 0.7 |
| | O₃P₃Q₄ | O₃P₃ * P₃Q₄ | 0.15 |
| | O₃P₃Q₅ | O₃P₃ * P₃Q₅ | 0.15 |

Path weights are indicated in the weighted DAG 500 and may be determined in a formulaic manner based on extracted information concerning the property and qualifier. The travel recommendation program 110a, 110b may determine a magnitude of the property and qualifier based on the extracted information. This magnitude may be stored in the profile bank 406 or may be determined by the object affinity calculation engine 412 based on information about the property or quality that is stored in the profile bank 406. The weight may be based on a preference importance for a traveler or travel-related object. For example, if a traveler cares more about sites to be visited than the food to be eaten, a “site” property and associated qualifiers may in this embodiment be higher, e.g., closer to 1.0, than a “food” property and associated qualifiers.

In a step 218 of the travel recommendation process 200, an affinity score for the traveler profile and for other profiles are calculated. For two objects to be analyzed as a pair to generate an affinity score for the pair, matching object paths for the two objects are identified. The matching object paths include the two objects passing to a same property, e.g., P₁, and passing to a same qualifier, e.g., Q₁. An affinity object score is then calculated by adding the path weights of all of the matching paths. This affinity object score may be calculated via the formula:

Affinity(OᵢOₙ)=Σ PathWeight(OᵢPⱼQₖ)

wherein Oᵢ is the n^{th} object in the target object class. The PathWeight(OᵢPⱼQₖ) represents all of the matched paths of the object Oᵢ with respect to the comparison target object Oₙ. A recommended list of object pairs for the object Oᵢ may be derived by reverse-sorted affinity.

Affinity object scores for the weighted DAG 500 shown in FIG. 5 are provided as examples in Table 2 below.

TABLE 2
Potential Pairing of Object 1 and Object 2

| Object | Q₁ | Q₂ | Q₃ | Sum |
|---|---|---|---|---|
| O₁ (Traveler 1) | 0.2 | 0.2 | 0.4 | 0.8 |
| O₂ (Traveler 2) | 0.42 | 0.28 | 0.3 | 1.0 |

Potential Pairing of Object 1 and Object 3

| Object | Q₂ | Q₄ | Q₅ | Sum |
|---|---|---|---|---|
| O₁ (Traveler 1) | 0.2 | 0.08 | 0.12 | 0.4 |
| O₃ (Traveler 3) | 0.7 | 0.15 | 0.15 | 1.0 |

An affinity calculation may then include comparing affinity similarity for a first potential pairing compared to the affinity similarity for a second potential pairing.

In a step 220 of the travel recommendation process 200, affinity scores are compared to find another traveler profile to recommend as a travel partnership. Those affinity scores that are compared may be those that were calculated in step 218. For the example above made with respect to the weighted DAG 500 from FIG. 5, the affinity score comparisons may occur in one way as shown in Table 3 below:

TABLE 3

| Affinity | Score |
|---|---|
| Object 1 − Object 2 | \|0.8 − 1\| = \|−0.2\| = 0.2 |
| Object 1 − Object 3 | \|0.4 − 1\| = \|−0.6\| = 0.6 |

A lower score may indicate a greater affinity for the pair. Thus, in this example the Object 1-Object 2 pair has a greater affinity than the Object 1-Object 3 pair. In this simple comparison, for Object 1 Object 2 may be identified as a more promising pairing object than Object 3 would be. A ranking of affinities may be based on a lowest raw calculated score as shown above. A ranking of affinities may alternatively be based on a percentage determination, whereby a percentage of one summed score to the other summed score is the compared number, and a higher number indicates a greater affinity For example, with the alternative and the above numbers the Object 1-Object 2 pairing may have an 80% affinity compared to a 40% affinity for the Object 1-Object 3 pairing and the Object 1-Object 2 pairing would be identified as more desirable due to higher affinity percentage.

In a step 222 of the travel recommendation process 200, affinity scores are compared to find an activity to propose to the travel partnership. The activity may include travel to a particular travel destination. If the steps 216, 218, and 220 generate a travel partnership recommendation that includes pairing a first traveler with a second traveler, the steps 216, 218, and 220 may then be repeated to find an object that represents an activity, e.g., travel to a particular destination, that has the greatest affinity for the travel partnership. The potential activity may be compared by matching object paths and by summation of a weighted path for each of the matching object paths for an affinity to a first of the two travelers paired for a partnership and then again to a second of the two travelers paired for a partnership. The similarity between the first traveler affinity and the second traveler affinity may then be compared to similarities for other potential travel activities. A travel activity with the closest affinity between the first traveler and second traveler may be identified as a most promising activity to propose to the travel partnership.

For objects that are activities such as destinations instead of travelers, constraints and factors as opposed to personality traits may play a large role in the matched object paths. An object representing a destination in the object graph may have fewer paths to personality properties and qualities. For an object that is a personal host of a potential lodging, personality traits may also play a large factor for matching, because the personal host may have many paths to personality-related properties and qualities.

Steps 216, 218, 220 and/or 222 may be performed by an affinity score calculation module 416 that is depicted in FIG. 4 and that is part of the object affinity calculation engine 412. In order to perform one or more of these steps, the affinity score calculation module 416 may receive or access the object graph created by the object graph creation module 414.

In a step 224 of the travel recommendation process 200, one or more messages to present the recommended pairing(s) are generated and transmitted. These pairings may be the proposed travel partnership that was determined in step 220 and the proposed activity that was determined in step 222. This message may be generated via the travel recommendation program 110b that is disposed in the server 112. The generated message may be transmitted via the communication network 116 to the computer 102 which is being utilized be a first traveler who initiated a request to the travel recommendation program 110a, 110b for travel recommendations. The generated message may be transmitted via the communication network 116 to another computer that is being utilized or that was registered to another traveler whose profile was paired with the first traveler in the previous steps of the travel recommendation process 200. When an activity, destination, and/or lodging host was paired with a traveler in the previous steps of the travel recommendation process 200, the generated message may be transmitted via the communication network 116 to another computer that is being utilized by a representative of the activity or destination or by the lodging host.

This message may include a single proposal of a travel partner or may include a ranked list of multiple potential travel partners, e.g., the highest ranked potential travel partners. This message may include a single proposal of a travel activity or may include a ranked list of multiple potential travel activities, e.g., the highest ranked potential travel activities. When such ranked lists are generated and included, the multiple potentials may be listed in an order indicating their ranking as a potential pairing for a recommendation requester, e.g., may be listed in a descending order with the highest ranked other traveler/activity presented first and/or highest in the list. Affinity scores may be included in the message.

The message generation and transmission may be performed via a recommendation generator 418 that may be a module and that may receive the object affinity scores and/or recommendations from the object affinity calculation engine 412.

In a step 226 of the travel recommendation process 200, feedback regarding travelers and/or locations is received and analyzed. This feedback may be obtained via the travel recommendation program 110a, 110b generating and transmitting a message with one or more questions for the recipients of the recommendations. A website operated via the travel recommendation program 110a, 110b may also generate a graphical user interface feedback prompt which generates and presents questions to the recommendation recipients and stores and analyzes answers that are received to the questions. This feedback may be solicited immediately after presentation of the proposals or after the traveler or travel-related object have undertaken more travel experiences. For example, if a traveler proceeds according to the proposal and takes a trip with a proposed travel partner to a proposed destination, the travel recommendation program 110a, 110b may then request feedback about the trip and use this trip feedback to update the curation engine 404 and the object affinity calculation engine 412. Feedback may also be obtained through techniques that were performed in step 202 to obtain information to generate initial profiles. For example, data from indirect data sources may be further obtained in step 226 and then used to improve the travel recommendation program 110a, 110b and machine learning models of the travel recommendation program 110a, 110b. The feedback may be invoked via a cognitive feedback acquisition and enactment mechanism which may be implemented to continuously improve an object affinity score. A feedback obtaining module 420 depicted in FIG. 4 may perform the step 226.

This feedback may be used to enhance the safety of travel that is performed using the recommendations that are provided. If some pairings had less than optimal results, the feedback that is obtained may be used to identify which data was used for the travel recommendation process 200 and to generate a travel profile and may have had lower accuracy. This data may be deleted or a weight for the data may be adjusted, e.g., reduced for inaccurate data, in the data storage of the travel recommendation program 110a, 110b. If some data used in the travel recommendation process 200 was inaccurate or incorrect based on a party providing inaccurate information about themselves or a location, then feedback from another party who interacted with the first party may help verify or undercut the earlier information that was provided.

The feedback may be stored in a feedback database 422 that is depicted in FIG. 4. The feedback database may overlap with the RAM 908 that is shown in FIG. 6, in memory of a server within and connected to the communication network 116 such as the server 112, and/or in other memory in one or more remote servers that are accessible to the travel recommendation program 110a, 110b via the communication network 116 and/or via a wired connection.

From the feedback that was obtained in step 226, one or both of a qualifier and a property may be extracted from the feedback. Natural language processing may be performed on text of the feedback to extract a qualifier, a property, a sentiment, and/or an intensity of the foregoing. This extraction may be performed via an extraction module 424 that is depicted in FIG. 4 and that has access to the feedback stored in the feedback database 422.

Various portions of the travel recommendation program 110a, 110b may be updated based on the feedback that is obtained in step 226. For example, in at least some embodiments profiles in the profile bank 406 and an object graph database are updated based on the feedback. FIG. 4 shows an object graph database 428 which may store an object graph that was created and generated in step 214. Dimensions in the object graph may be hereby continuously added and/or updated based on conditional processing of deconstructed feedback. A database enhancement module 426 may perform these updates and database enhancements that were based on the received feedback.

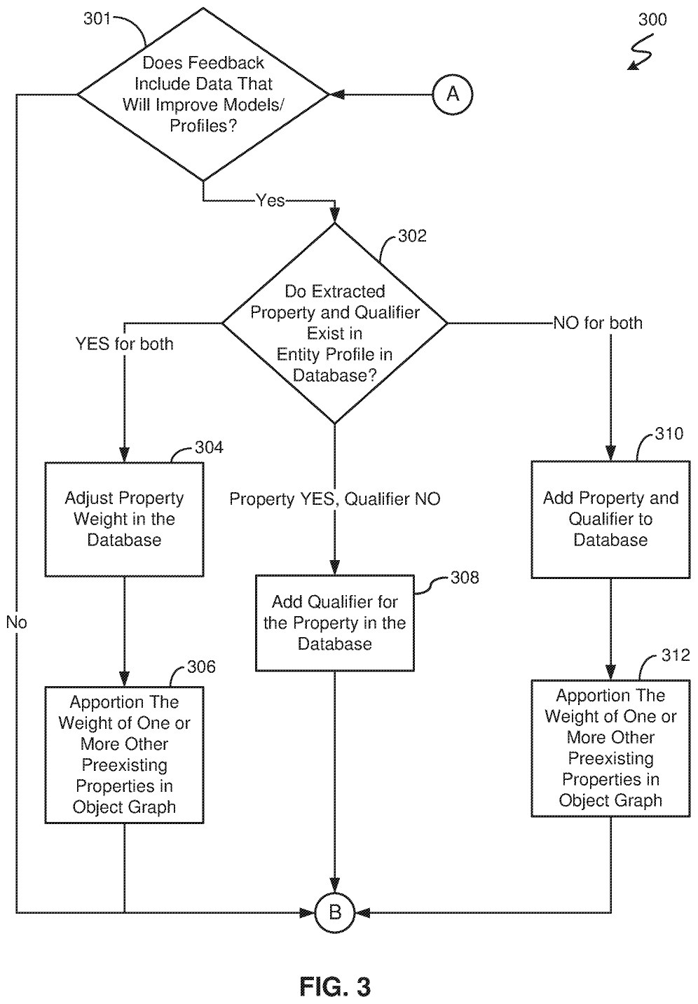

Exemplary details of these updates are set forth in the supplementary travel recommendation process 300 that is shown in FIG. 3. Point “A” in the travel recommendation process 200 shown in FIG. 2 represents a transfer to the point “A” in the supplementary travel recommendation process 300 shown in FIG. 3. Point “B” in the travel recommendation process 200 shown in FIG. 2 represents a return from the point “B” in the supplementary travel recommendation process 300 shown in FIG. 3.

The supplementary travel recommendation process 300 is explained below with an example in which a “food constraint” property, a “vegan” qualifier, and an intensity of “strictly” were extracted from feedback that was obtained from a traveler who was paired with another traveler via an iteration of the earlier steps of the travel recommendation process 200. The traveler provided the feedback “My recommended companion has totally different food preferences than I have. I am strictly vegan.”

From point “A” at the beginning of the supplementary travel recommendation process 300, step 301 occurs which is a determination as to whether the feedback includes data that will improve the models/profiles. These models may refer to machine learning models of the curation engine 404 and/or of the object affinity calculation engine 412. These profiles may refer to profiles that are stored in the profile bank 406, e.g., traveler profiles 408 and/or location profiles 410. This feedback may refer to the feedback that was received in step 226 of the travel recommendation process 200.

For a positive determination that the feedback includes data that will improve the models/profiles, the supplementary travel recommendation process 300 may proceed to step 302 in the supplementary travel recommendation process 300. For a negative determination that the feedback does not include data that will improve the models/profiles, the supplementary travel recommendation process 300 may proceed to point “B” in the supplementary travel recommendation process 300. Point “B” represents a return to the other point “B” shown in FIG. 2 in the travel recommendation process 200.

The determination of step 301 may occur by analyzing any text that was received in step 226. In some instances, a user may in confusion type in incoherent or meaningless feedback. A user may want to avoid giving any feedback and may click a few boxes or type in an incoherent small set of words to try to escape a feedback graphical user interface of the travel recommendation program 110a, 110b, e.g., that they are experiencing on the travel recommendation website. The feedback obtaining module 420 may perform text analysis to determine if the text received includes coherent and/or declarative statements. If the feedback obtaining module 420 interprets the feedback text as incoherent, the determination of step 301 is that the feedback will not improve the machine learning models. A profile for a user may be updated to indicate that the user avoids giving feedback. In this instance when the feedback obtaining module 420 interprets the feedback text as not improving the machine learning models and/or the profiles, the remaining portions of the supplementary travel recommendation process 300 may be bypassed and the point “B” may return the process back to the point “B” in the travel recommendation process 200 shown in FIG. 2. If the feedback obtaining module 420 interprets the text to have some meaning or affirmative feedback the determination of step 301 is that the feedback will improve the machine learning models and/or the profiles. Thus, the supplementary travel recommendation process 300 would proceed to step 302.

In a step 302 of the supplementary travel recommendation process 300 that is shown in FIG. 3, a determination is made as to whether an extracted property and qualifier exist in an entity profile in the database. The database may be the object graph database 428 shown in FIG. 4 which stores an object graph that was generated in step 214. This generated object graph, e.g., the weighted DAG 500 shown in FIG. 5, may be used in subsequent performances of the travel recommendation process 200 to generate new recommendations for a user of the travel recommendation program 110a, 110b. Thus, storage of the generated object graph, e.g., in the object graph database 428, may facilitate quicker recommendation processing when future travel recommendations are requested by previous users of the travel recommendation program 110a, 110b. Text comparison features may be used to compare the extracted property and qualifier with the names of other properties and qualifiers that are already saved and had nodes in the object graph. An exact text match may be performed in some embodiments. A base word or an approximate text match may be performed in some embodiments.

For a double positive determination that both an extracted property and an extracted qualifier already exist in the database, the supplementary travel recommendation process 300 may proceed to step 304 in the supplementary travel recommendation process 300. For a half positive determination that an extracted property already exists in the database but the extracted qualifier does not already exist in the database, the supplementary travel recommendation process 300 may proceed to step 308 in the supplementary travel recommendation process 300. For a double negative determination that both an extracted property and an extracted qualifier do not already exist in the database, the supplementary travel recommendation process 300 may proceed to step 310 in the supplementary travel recommendation process 300.

For the above-introduced example with a “food constraint” property, a “vegan” qualifier, and an intensity of “strictly” being extracted, in the first branch (i.e., for steps 304 and 306) the object graph database 428 was analyzed and found to already include “food constraint” as a property and “vegan” as a qualifier.

In a step 304 of the supplementary travel recommendation process 300 that is shown in FIG. 3, a weight of the property is adjusted in the database. This property may be that extracted property that was analyzed in step 302. The weight of the property may be increased due to this additional finding of said property. The weight may be adjusted based on an intensity or magnitude of the incidence of said property that was extracted from the feedback. In some examples, the adjustment may occur by doubling the existing property weight, i.e., by multiplying the existing property weight by two. For the specific above example regarding food property and vegan qualifier, the food constraint property weight “0.2” (shown between first third property 512a and the first object 502) may be doubled and may thereafter be 0.4.

Similarly, a weight for the qualifier may also be adjusted based on the extracted qualifier that was analyzed in step 302.

In a step 306 of the supplementary travel recommendation process 300 that is shown in FIG. 3, the weight of one or more other preexisting properties in the object graph is adjusted in the database. To the extent that other properties for a traveler of other travel-related object are affected by the incidence of the property identified in the extraction from the feedback, then the weights of these other properties may be adjusted downwards or upwards depending on the effect.

For the specific above example regarding food property and vegan qualifier, the other properties, namely the first first property 508a and the first second property 510a, associated with the first object 502 may each be reduced from 0.4 to 0.3. Namely, the weight of the path segment from the first object 502 to the first first property 508a and to the first second property 510a may each be reduced from 0.4 to 0.3. In this example, the first property may be travel calendaring considerations. The second property may be travel activity preferences.

In some embodiments, an adjustment of weights for other properties based on changing a weight for another property or based on adding a new property with a weight occurs due to a system in which weights for all properties and qualifiers for an object add up to a total which is equal to the total for other objects. For example, the weights for all of the properties and associated qualifiers for a particular object may sum to 100, and the weights for all of the properties and associated qualifiers for other objects in the same object graph would also sum to 100. In the absence of any user rating, a default start position for the weights may be the total maximum number divided by the number of properties and qualifiers. For example, with seven properties and thirteen qualifiers, each weight may be five due to dividing one hundred by twenty. If a user rating is available, then weight adjustments based on the user rating may from that point be implemented into the object graph. Intensity and/or magnitude levels of feedback that are received may subsequently be used to adjust the apportionment of weight to a property and associated qualifiers in an object graph.

After step 306 the supplementary travel recommendation process 300 proceeds to point “B” which transfers back to point “B” in the travel recommendation process 200 that is shown in FIG. 2.

For the above-introduced example with a “food constraint” property, a “vegan” qualifier, and an intensity of “strictly” being extracted, in the second exemplary branch (i.e., with step 308) the object graph database 428 was analyzed and found to already include “food constraint” as a property but not “vegan” as a qualifier. Referring to the example of the weighted DAG 500 in FIG. 5 in which the P3 is a food property, for this example of the second branch of the supplementary travel recommendation process 300 neither the Q4 nor the Q5 would be a “vegan” qualifier.

In a step 308 of the supplementary travel recommendation process 300 that is shown in FIG. 3, the qualifier for the property is added to the database. This qualifier may be that extracted qualifier that was analyzed in step 302. This addition to the database may result in a new third-level node being generated for the new qualifier or in a new path from an existing third-level node to a property node when these two nodes (second level and third level) previously were not directly linked via a direct path. This qualifier may be added with a weight for its path from the pre-existing property. The weight may be determined based on an intensity or magnitude of the incidence of said qualifier that was extracted from the feedback.

For the specific above example regarding food property and vegan qualifier, in this second sub-example the pre-existing food constraint property had pre-existing qualifiers of non-vegetarian and vegetarian, and the traveler had been assigned to vegetarian. Based on the feedback that the user has been asked to be strictly considered as a vegan, a new qualifier and corresponding qualifier node for “vegan” are added to the object graph so that an object path runs from the food constraint node (second level) to the new vegan node (third level). The new vegan node may be considered a third-level node in a three level directed acyclic graph.

In some embodiments, no changes to weights are necessary for this second branch. Alternatively, a weight for the first path segment from the object node to the food constraint node may be increased due to an increased awareness of the intensity with which this traveler holds their food priorities.

After step 308 the supplementary travel recommendation process 300 proceeds to point “B” which transfers back to point “B” in the travel recommendation process 200 that is shown in FIG. 2.

For the above-introduced example with a “food constraint” property, a “vegan” qualifier, and an intensity of “strictly” being extracted, in the third exemplary branch (i.e., with steps 310 and 312) the object graph database 428 was analyzed and found to include neither “food constraint” as a property nor “vegan” as a qualifier.

In a step 310 of the supplementary travel recommendation process 300 that is shown in FIG. 3, the property and the qualifier are added to the database. This property and this qualifier may be those that were extracted and then analyzed in step 302. These additions to the database may result in a new second-level node being generated for the property and a new third-level node being generated for the new qualifier. Alternatively, the additions may be of a new path from an existing first level node to an existing second level node that was not previously directly linked to that first level node. This property and this qualifier may be added with respective weights for their paths or path segments from the object and from this property, respectively. The weights may be determined based on an intensity or magnitude of the incidence of said property and qualifier that were extracted from the feedback.

For the specific above example regarding food property and vegan qualifier, in this third branch, i.e., in the third sub-example, there was no information about the food preferences of this traveler. Based on the feedback that the user has been asked to be strictly considered as a vegan, a new property and property node for “Food constraint” are added for the object graph. Also, a new qualifier and corresponding qualifier node for “vegan” are added to the object graph. The new property node and qualifier node are added so that an object path runs from the respective object node representing the traveler to new food constraint property node, and then from the new food constraint property node to the new vegan qualifier node. The new food constraint node may be considered a second-level node in the directed acyclic graph. The new vegan node may be considered a third-level node in a three level directed acyclic graph. As this third branch may relate to the second object 504, this new food constraint node may be added as a new property node P3 connected to the second object 504 and as a new qualifier node connected to the new property node P3. Thus, these two additions relate to unshown additions on the weighted DAG 500 shown in FIG. 5.

In a step 312 of the supplementary travel recommendation process 300 that is shown in FIG. 3, the weight of one or more other preexisting properties in the object graph are adjusted in the database. To the extent that other properties for a traveler of other travel-related object are affected by the incidence of the property and qualifier that are identified in the extraction from the feedback, then the weights of these other properties may be adjusted downwards or upwards depending on the effect.

For the specific above example regarding food property and vegan qualifier, in this third branch, other properties, namely the other first property 508b of group size may be adjusted to have a weight of 0.5 instead of 0.7. The other second property 510b may also be adjusted to have its weight reduced to 0.2 instead of 0.3.

For step 312, in some embodiments, an adjustment of weights for other properties based on changing a weight for another property or based on adding a new property with a weight occurs due to a system in which weights for all properties and qualifiers for an object add up to a total which is equal to the total for other objects. Thus, concept was explained above with respect to step 306 in the first branch of the supplementary travel recommendation process 300.

After step 312 the supplementary travel recommendation process 300 proceeds to point “B” which transfers back to point “B” in the travel recommendation process 200 that is shown in FIG. 2.

A summary of these three branch options for this specific embodiment of a strict vegan food preference is indicated in Table 4 below:

TABLE 4

| | | Illustrative | |
|---|---|---|---|
| Step | Conditional Step | Feedback Use case | Illustrative Action |
| Apply NLP to extract | | PROPERTY = | |
| the property and | | FOOD | |
| qualifier influencing | | CONSTRAINT; | |
| the feedback Extract | | QUALIFIER = | |
| sentiment and | | VEGAN; | |
| intensity | | INTENSITY = | |
| | | STRICTLY | |
| Search | | | |
| Object/customer | | | |
| graph for the | | | |
| extracted property | | | |
| and qualifier | | | |
| Search Outcome #1 | If property and | Traveler O₁ has | Adjusted Property |
| | qualifier both exist | PROPERTY = | Weights |
| | | FOOD | FOOD |
| | | CONSTRAINT and | CONSTRAINT 2 * |
| | | QUALIFIER = | 0.2 = 0.4 |
| | | VEGAN | CALENDARING = |
| | | | 0.3 |
| | | | ACTIVITIES = 0.3 |
| Search Outcome #2 | If property exists but | Traveler O₁ has | Add Qualifier = |
| | not qualifier | PROPERTY = | VEGAN for |
| | | FOOD | PROPERTY = |
| | | CONSTRAINT | FOOD |
| | | QUALIFIER has | CONSTRAINT |
| | | values [NON- | Align graph to point |
| | | VEGETARIAN, | to VEGAN for |
| | | VEGETARIAN] with | FOOD |
| | | Traveler O₁ assigned | CONSTRAINT |
| | | to VEGETARIAN | No changes to other |
| | | Traveler has asked | weights |
| | | for strictly VEGAN | |
| Search Outcome #3 | If neither property | Traveler O₂ does not | Add PROPERTY = |
| | nor qualifier exists | have PROPERTY = | FOOD CONSTRAINT |
| | | FOOD | and QUALIFIER = |
| | | CONSTRAINT and | VEGAN |
| | | QUALIFIER = | Adjusted Weights: |
| | | VEGAN | FOOD |
| | | | CONSTRAINT 0.3 |
| | | | ACTIVITIES 0.2 |
| | | | CALENDARING 0.5 |

The supplementary travel recommendation process 300 may improve recommendations for future recommendation for a user of the travel recommendation program 110a, 110b, because more data points may be relied on for generating the object graph and the one or more recommendations.

The feedback data acquisition described herein may update in the travel recommendation program 110a, 110b the interests and a constraint profile of a tourist based on latest selections during a matching and/or recommendation phase. For example, if a list of top potential pairs are presented and a user selects one of the proposals, the travel recommendation program 110a, 110b may save information about the selected choice and may ask the user for feedback to better understand the choice made.

While travel commences, subject to privacy laws and consent and service being accepted, a tourist may be prompted by the travel recommendation program 110a, 110b to rate by dimensions of preferences and constraints tourist spots along the way and tourist spots visited. Further dimensions and locations may be added into the system based on the travel of the tourist and entry by the tourist of the information into databases and/or the profile bank 406 of the travel recommendation program 110a, 110b or based on scraping techniques used by the travel recommendation program 110a, 110b when the user shares new information online, e.g., in social media, in other travel rating websites, or in other electronic messages, about places visited.

After travel, a consolidated review, consolidated feedback, and recommendations regarding the travel experience may be solicited from the travelers by the travel recommendation program 110a, 110b and may be input into the databases and/or profile bank 406 of the travel recommendation program 110a, 110b.

Thus, the step 226 and the supplementary travel recommendation process 300 may be performed before a trip and after the recommendation presentation (e.g., transmittal), during the trip, and/or after the trip. The feedback that is received may be further used to train one or more machine learning models that are part of the curation engine 404 and/or the object affinity calculation engine 412.

In a step 232 of the travel recommendation process 200, a determination is made as to whether another traveler is requesting recommendations. For a negative determination that no additional recommendation request has been received, the travel recommendation process 200 may proceed to the end of the travel recommendation process 200. For a positive determination that another recommendation request from a traveler has been received, the travel recommendation process 200 may proceed to step 234 for another determination. This determination may be made by checking for a recommendation request input signal from usage of a website operated by the travel recommendation program 110a, 110b. Users on various computer connected to the communication network 116 may access such website using their personal computer to initiate a travel recommendation request from the travel recommendation program 110a, 110b

In a step 234 of the travel recommendation process 200, a determination is made as to whether the traveler requesting recommendations has a profile. For a negative determination that no profile has already been generated for the traveler, the travel recommendation process 200 may proceed to step 202 so that a profile may be generated for this traveler. For a positive determination that a profile for the other requesting traveler already has been generated, the travel recommendation process 200 may proceed to step 210 to proceed to analysis of the existing profile and to comparison of the existing profile with other profiles. A name associated with the request may be compared to names stored with profiles in the profile bank 406. If a match, partial match, or no match is indicated in the automated comparison, the travel recommendation program 110a, 110b may generate a graphical user interface prompt for display at a computer screen of the user to ask for confirmation of whether or not a profile has already been generated for said user.

Thus, the travel recommendation process 200 may include using a matching algorithm, creating a subset of tourist spots by matching dimensions against tourist interests, filtering tourist spots within the subset based on a tourist eligibility threshold, further ranking the subset by a dimensional rank by surfacing the top recommendations for the tourist, and by further adding provisions to modify interest areas and/or constraints and re-reevaluate. The travel recommendation program 110a, 110b may be used to make recommendations for many-many/many-one/one-many traveler and locations and/or co-relations through a framework to deduce and rank interest to create a pairing taxonomy.

In some embodiments, an object for the object graph will represent a particular audio tour of a particular destination or site. Multiple audio tours may be available at a site to give tour explanations to tourists who visit. Each of the various audio tours may have distinct characteristics that would appeal differently to visitors with different personalities and/or tastes. The travel recommendation process 200 may be applied to generate a profile for each of the various audio tours so that a visitor could use the travel recommendation process 200 to receive a recommendation for which of the audio tours matches best to the respective visitor. Likewise, for an audio tour that includes an automated QA system such as IBM Watson® (IBM and all IBM-based trademarks and logos are trademarks or registered trademarks of International Business Machines Corporation and/or its affiliates), the automated QA device may have various settings for which profiles can be generated and stored and matched with visiting tourists. The travel recommendation program 110a, 110b may perform the above-described matching analysis to determine which of the various settings for the automated QA device would be a best match for a visitor and may generate a recommendation message for the visitor of that particular automated QA device setting. For example, some audio tours may give more detail and/or may inject more humor into the audio tour. Some visitors may match better with certain tours. Similar implementations may be used to match visitors to various human tour guides and/or to walking routes.

It may be appreciated that FIGS. 2-5 provide only illustrations of some embodiments and do not imply any limitations with regard to how different embodiments may be implemented. Many modifications to the depicted embodiment(s), e.g., to a depicted sequence of steps, may be made based on design and implementation requirements.

FIG. 6 is a block diagram 600 of internal and external components of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 602a, 602b, 604a, 604b is representative of any electronic device capable of executing machine-readable program instructions. Data processing system 602a, 602b, 604a, 604b may be representative of a smart phone, a computer system, PDA, or other electronic devices. Examples of computing systems, environments, and/or configurations that may represented by data processing system 602a, 602b, 604a, 604b include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and server 112 may include respective sets of internal components 602a, 602b and external components 604a, 604b illustrated in FIG. 6. Each of the sets of internal components 602a, 602b includes one or more processors 606, one or more computer-readable RAMs 608 and one or more computer-readable ROMs 610 on one or more buses 612, and one or more operating systems 614 and one or more computer-readable tangible storage devices 616. The one or more operating systems 614, the software program 108a, and the travel recommendation program 110a in client computer 102, the software program 108b and the travel recommendation program 110b in server 112, may be stored on one or more computer-readable tangible storage devices 616 for execution by one or more processors 606 via one or more RAMs 608 (which typically include cache memory). In the embodiment illustrated in FIG. 6, each of the computer-readable tangible storage devices 616 is a magnetic disk storage device of an internal hard drive. Alternatively, each of the computer-readable tangible storage devices 616 is a semiconductor storage device such as ROM 610, EPROM, flash memory, or any other computer-readable tangible storage device that can store a computer program and digital information.

Each set of internal components 602a, 602b also includes a RAY drive or interface 618 to read from and write to one or more portable computer-readable tangible storage devices 620 such as a CD-ROM, DVD, memory stick, magnetic tape, magnetic disk, optical disk or semiconductor storage device. A software program, such as the software program 108, and the travel recommendation program 110a, 110b can be stored on one or more of the respective portable computer-readable tangible storage devices 620, read via the respective R/W drive or interface 618 and loaded into the respective hard drive 616.

Each set of internal components 602a, 602b may also include network adapters (or switch port cards) or interfaces 622 such as a TCP/IP adapter cards, wireless wi-fi interface cards, or 3G or 4G wireless interface cards or other wired or wireless communication links. The software program 108 and the travel recommendation program 110a in client computer 102, the software program 108b and the travel recommendation program 110b in the server 112 can be downloaded from an external computer (e.g., server) via a network (for example, the Internet, a local area network or other, wide area network) and respective network adapters or interfaces 622. From the network adapters (or switch port adaptors) or interfaces 622, the software program 108 and the travel recommendation program 110a in client computer 102 and the travel recommendation program 110b in server 112 are loaded into the respective hard drive 616. The network may include copper wires, optical fibers, wireless transmission, routers, firewalls, switches, gateway computers and/or edge servers.

Each of the sets of external components 604a, 604b can include a computer display monitor 624, a keyboard 626, and a computer mouse 628. External components 604a, 604b can also include touch screens, virtual keyboards, touch pads, pointing devices, and other human interface devices. Each of the sets of internal components 602a, 602b also includes device drivers 630 to interface to computer display monitor 624, keyboard 626 and computer mouse 628. The device drivers 630, R/W drive or interface 618 and network adapter or interface 622 include hardware and software (stored in storage device 616 and/or ROM 610).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

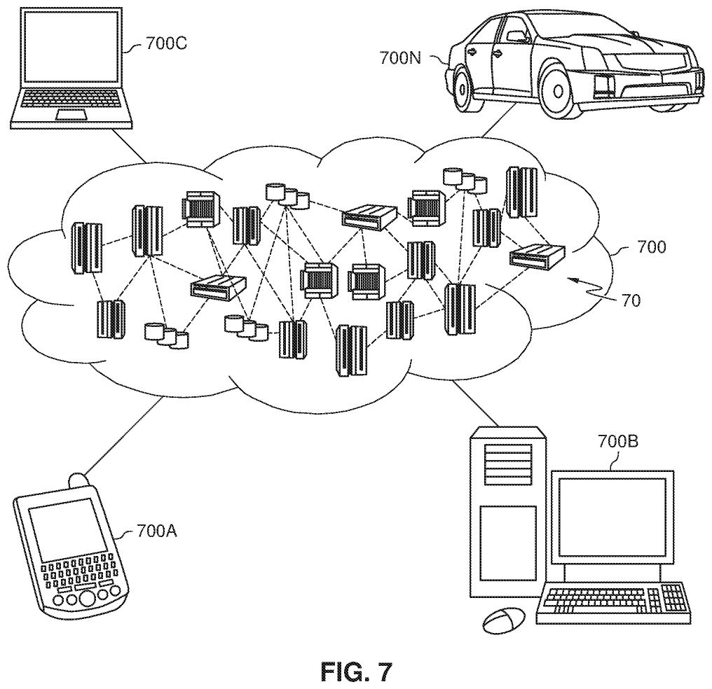

Referring now to FIG. 7, illustrative cloud computing environment 700 is depicted. As shown, cloud computing environment 700 comprises one or more cloud computing nodes 70 with which local computing devices used by cloud consumers, such as, for example, personal digital assistant (PDA) or cellular telephone 700A, desktop computer 700B, laptop computer 700C, and/or automobile computer system 700N may communicate. Nodes 70 may communicate with one another. They may be grouped (not shown) physically or virtually, in one or more networks, such as Private, Community, Public, or Hybrid clouds as described hereinabove, or a combination thereof. This allows cloud computing environment 700 to offer infrastructure, platforms and/or software as services for which a cloud consumer does not need to maintain resources on a local computing device. It is understood that the types of computing devices 700A-N shown in FIG. 7 are intended to be illustrative only and that computing nodes 70 and cloud computing environment 700 can communicate with any type of computerized device over any type of network and/or network addressable connection (e.g., using a web browser). The computer 102 and the server 112 shown in FIG. 1 may be examples of the nodes 70 that are shown in FIG. 7.

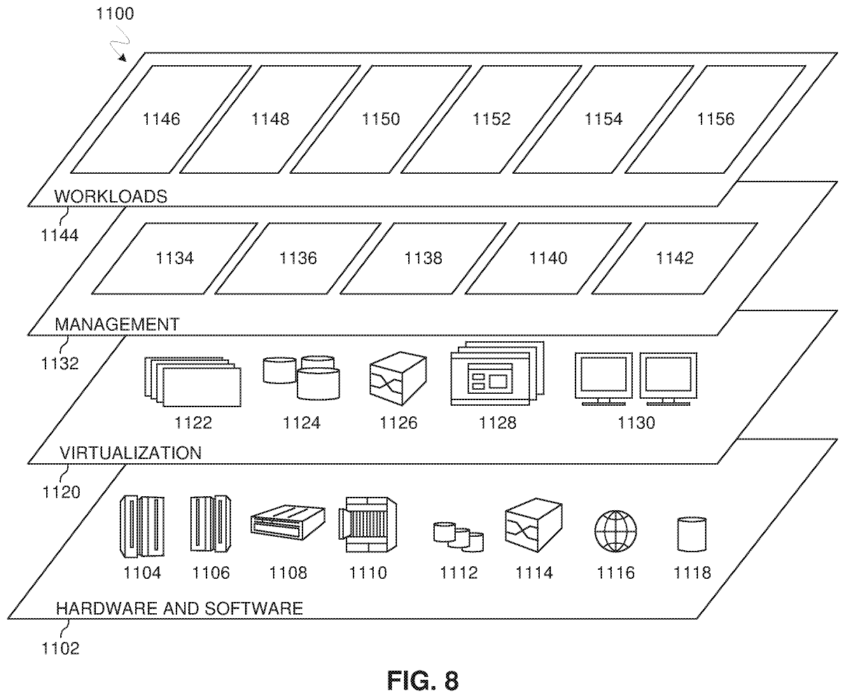

Referring now to FIG. 8, a set of functional abstraction layers 1100 provided by cloud computing environment 700 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and travel recommendation 1156. A travel recommendation program 110a, 110b provides a way to enhance travel enjoyment by providing improved travel partner pairing and travel activity recommendations in a way that promotes safety.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for travel recommendation enhancement, the method comprising:
inputting a first travel profile comprising travel preferences into a first machine learning model;
in response to the inputting, receiving, from the first machine learning model, a second travel profile as a match for the first travel profile, wherein the first machine learning model searches a database of travel profiles and generates at least one weighted directed acyclic graph based on properties of the travel profiles to determine the match, wherein first and second nodes of the at least one weighted directed acyclic graph correspond to the first travel profile and to the second travel profile, respectively; and
generating and transmitting one or more messages presenting the match.

2. The method of claim 1, wherein:
the first and the second travel profiles represent first and second travelers, respectively, and
the method further comprises:
inputting the first and the second travel profiles together into the first machine learning model;
in response to the inputting of the first and the second travel profiles together, receiving from the first machine learning model a third travel profile that matches the first and the second travel profiles, the third travel profile corresponding to a travel activity; and
generating and transmitting one more messages presenting the travel activity to at least one of the first and second travelers.

3. The method of claim 2, wherein the travel activity comprises a travel destination.

4. The method of claim 1, wherein:
the first travel profile represents a first traveler, and
the second travel profile represents a member selected from the group consisting of a second traveler, a host, an audio tour presentation, a tour guide, an activity, and a destination.

5. The method of claim 1, wherein to determine the match the machine learning model finds matching object paths within the at least one weighted directed acyclic graph between nodes of profiles being compared and calculates a respective affinity score by adding path weights of the matching object paths.

6. The method of claim 1, further comprising:
receiving feedback regarding at least one of the first travel profile and the second travel profile; and
updating an object graph database with the feedback, the first machine learning model accessing the object graph database to determine matches.

7. The method of claim 6, further comprising performing natural language processing on the feedback in order to perform the updating.

8. The method of claim 1, further comprising generating the database of travel profiles via ingesting data from direct and indirect data sources.

9. The method of claim 8, wherein:
the ingesting comprises inputting the data into another machine learning model; and
the other machine learning model provides, as output, the profiles for the database of the profiles.

10. The method of claim 1, further comprising:
receiving feedback regarding at least one of the first travel profile and the second travel profile; and
updating the first travel profile and the second travel profile in the database of profiles based on the feedback.

11. The method of claim 1, wherein the at least one weighted directed acyclic graph is further based on at least one member selected from group consisting of constraints of the travel profiles and qualifiers of the properties.

12. A computer system for travel recommendation enhancement, the computer system comprising:
one or more processors, one or more computer-readable storage mediums, and program instructions stored on at least one of the one or more computer-readable storage mediums for execution by at least one of the one or more processors to cause the computer system to:
input a first travel profile comprising travel preferences into a first machine learning model;
in response to the inputting, receive, from the first machine learning model, a second travel profile as a match for the first travel profile, wherein the first machine learning model searches a database of travel profiles and generates at least one weighted directed acyclic graph based on properties of the travel profiles to determine the match wherein first and second nodes of the at least one weighted directed acyclic graph correspond to the first travel profile and to the second travel profile, respectively; and
generate and transmit one or more messages presenting the match.

13. The computer system of claim 12, wherein:
the first and the second travel profiles represent first and second travelers, respectively, and
the program instructions are further for causing the computer system to:
input the first and the second travel profiles together into the first machine learning model;
in response to the inputting of the first and the second travel profiles together, receive from the first machine learning model a third travel profile that matches the first and the second travel profiles, the third travel profile corresponding to a travel activity; and
generate and transmit one more messages presenting the travel activity to at least one of the first and second travelers.

14. The computer system of claim 13, wherein the travel activity comprises a travel destination.

15. The computer system of claim 12, wherein:
the first travel profile represents a first traveler, and
the second travel profile represents a member selected from the group consisting of a second traveler, a host, an audio tour presentation, a tour guide, an activity, and a destination.

16. The computer system of claim 12, wherein to determine the match the machine learning model finds matching object paths in the at least one weighted directed acyclic graph between nodes of profiles being compared and calculates a respective affinity score by adding path weights of the matching object paths.

17. A computer program product for travel recommendation enhancement, the computer program product comprising a computer-readable storage medium having program instructions embodied therewith, wherein the program instructions are executable by a computer system to cause the computer system to:
input a first travel profile comprising travel preferences into a first machine learning model;
in response to the inputting, receive, from the first machine learning model, a second travel profile as a match for the first travel profile, wherein the first machine learning model searches a database of travel profiles and generates at least one weighted directed acyclic graph based on properties of the travel profiles to determine the match, wherein first and second nodes of the at least one weighted directed acyclic graph correspond to the first travel profile and to the second travel profile, respectively; and
generate and transmit one or more messages presenting the match.

18. The computer program product of claim 17, wherein:
the first and the second travel profiles represent first and second travelers, respectively, and
the program instructions are further for causing the computer system to:
input the first and the second travel profiles together into the first machine learning model;
in response to the inputting of the first and the second travel profiles together, receive from the first machine learning model a third travel profile that matches the first and the second travel profiles, the third travel profile corresponding to a travel activity; and
generate and transmit one more messages presenting the travel activity to at least one of the first and second travelers.

19. The computer program product of claim 18, wherein the travel activity comprises a travel destination.

20. The computer program product of claim 17, wherein:
the first travel profile represents a first traveler, and
the second travel profile represents a member selected from the group consisting of a second traveler, a host, an audio tour presentation, a tour guide, an activity, and a destination.
